(19) United States
(12) Patent Application Publication
(10) Pub. No.: US 2011/0209981 A1
(43) Pub. Date: Sep. 1, 2011

(54) BIODIESEL PURIFICATION METHOD

(75) Inventors: Carlos Nagib Khalil, Rio de Janeiro (BR); Rodolfo de Vico, Rio de Janeiro (BR); Andre Manoel Goja Ferreira, Rio de Janeiro (BR); Bianca Machado da Silva Ferreira, Rio de Janeiro (BR); Carlos Alberto Dias Da Silva, Rio de Janeiro (BR)

(73) Assignee: PETROLEO BRASILEIRO S.A-PETROBRAS, Rio de Janeiro, RJ (BR)

(21) Appl. No.: 13/062,172

(22) PCT Filed: Sep. 3, 2009
(86) PCT No.: PCT/BR2009/000273

§ 371 Date: May 12, 2011

(30) Foreign Application Priority Data
Sep. 4, 2008 (BR) PI 0804083-4

(51) Int. Cl. B01J 19/08; B01D 17/06

(52) U.S. Cl. 204/168

(57) ABSTRACT

The present invention concerns a process for purification of biodiesel obtained from castor seed oil for the purpose of promoting the efficient separation of the glycerine fraction formed during the transesterification reaction of a mixture of long-chain triglycerides derived from the oil in the presence of ethanol and an alkaline catalyst.

The invention concerns the application of the method of electrostatic separation to biodiesel from castor oil in order to separate the glycerine from the stable emulsion then formed, in relatively short spaces of time.

### FIELD OF THE INVENTION

The present invention concerns a process for purification of biodiesel for the purpose of promoting the efficient separation of the glycerine fraction formed during transesterification of a mixture of long-chain triglycerides derived from vegetable and/or animal oils, with the aim of obtaining biodiesel (mixture of esters), in a relatively short time, between the first and second transesterification reaction step, and, if necessary, also in the final product purification steps, the biodiesel fraction and the glycerine fraction.

More specifically, the present invention concerns the application of a method for electrostatic separation of the glycerine fraction to conventional processes for the industrial production of biodiesel.

### BASES OF THE INVENTION

For the industrial production of biodiesel—a renewable fuel substitute of diesel from oil—the alkaline transesterification reaction of triglycerides, such as vegetable oils or even animal fat is commonly used, in the presence of a primary alcohol, in particular methanol and ethanol. The catalyst used, in a range of 0.5% to 1.5%, comes from hydroxides or alkoxides (methoxides and ethoxides) of alkaline metals, such as sodium and potassium. The commercial product known as biodiesel is chemically classified as a mixture of alquidic esters of fatty acids obtained by means of a transesterification reaction.

Nevertheless, the transesterification of triglycerides is a reversible

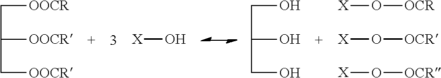

reaction and its equilibrium is highly dependent upon the molar ratio between the reagents. Intermediate products of the alcoholysis, such as mono- and diglycerides, are formed in varying concentrations, thus establishing a complex equilibrium between the classes.

The surplus of alcohol may favour the displacement in the reaction in the direction of the products, but it will be difficult to achieve full conversion from the reaction. On the other hand, both the use of an excess of alcohol in relation to the stoichiometric equilibrium value of 1:3, and the generation of glycerine equivalent to 1 mol for each mol of vegetable oil, promote an undesirable stabilisation of the ternary mixture (esters\alcohol\glycerine) resulting from the primary step of the transesterification reaction.

A solution that can be adopted to reach higher conversion factors is to perform the process in two steps, but to do this it is first necessary to remove the glycerine produced in the first step.

However, the full removal of the glycerine content generated in the first step requires relatively long dwell times in the decanting vessels. The inefficiency of the glycerine removal compromises execution of the second step of the transesterification reaction, and, consequently, reduces the quality of the final biodiesel and the overall yield from the process.

The present invention aims the insertion and implementation of a stage of a process to promote the efficient separation of the glycerine fraction, in relatively short time between the first and second transesterification reaction step, and, if necessary, in the purification steps of final products: the biodiesel fraction and the glycerine fraction.

### RELATED METHOD

The Brazilian patent application PI 0105888-6 relates to a process for the production of biodiesel, which is obtained directly from oleaginous seeds rich in triglycerides, preferably castor seeds, by means of a transesterification reaction in which the seeds themselves are brought into a reaction with anhydrous ethanol in the presence of an alkaline catalyst, to generate ethyl esters and glycerine as by-product. These esters are separated by decantation, neutralised and used as fuel for diesel motors, or in mixtures of diesel with gasoline or ethanol.

The glycerine fraction separation step in the industrial process for biodiesel production is conventionally handled as a separate operation of the gravitational or centrifugal decantation type, almost always preceded by the addition of percentages of water in a range of 5% to 20%.

The presence of water in the ternary system (esters\alcohol\glycerine) promotes a reduction in viscosity and an increase in polarity of the glycerine fraction, which are highly advantageous in its decantation under conditions of rest or centrifugation.

However, the presence of intermediate compounds from the transesterification reaction, such as mono- and diglycerides, or saponified compounds, originating from secondary reactions between the alkaline catalyst and the triglycerides, leads to the stabilisation of a persistent emulsified system. The stable emulsion contains the hydrated glycerine as a dispersed phase; the esters and mono- and diglyceride intermediate compounds as a dispersing phase; and the saponified compounds as emulsifying agents. The alcohol component in the process is subdivided in proportion between the two phases.

A theoretical alternative in order to overcome the glycerine separation problem would be to reduce the alcohol content by distillation and subsequent neutralisation of the catalyst, with the addition of a mineral acid. Such steps, however, would eventually lead to other problems for the purification process, such as the partial reversal of the reaction—with the formation once again of the intermediate compounds (mono- and di-glycerides) and the precipitation of fatty acids—due to the neutralisation of the saponified compounds. The break-even point of these two actions is of difficult adjustment and highly dependent upon the characteristics of the reaction charge.

Methanol, being more reactive than ethanol, is frequently more used in industrial processes. However, due to its harmfulness it is being replaced by ethanol which beyond being less toxic it can be obtained of a renewable source.

On the other hand, the type of catalyst used, the reaction conditions and the type and concentration of impurities in the reaction medium, determine the course of, the yield from and the by-products obtained in, the transesterification of the triglycerides.

One of these by-products of the reaction is the formation of soaps, which leads to stable emulsions. Under agitation, the glycerine disperses in the biodiesel in the form of small droplets; with their surfactant action, the molecules of soap deposit on the surface of the droplets giving origin to emulsion. For this reason, the step in which the glycerine is separated from the biodiesel constitutes a critical step in the industrial process.

The process of purification now being proposed, aims to solve this problem by reducing drastically the time for separation of the phases.

The present invention concerns the application of an electrostatic separation method to the conventional processes for industrial production of biodiesel.

### SUMMARY OF THE INVENTION

The present invention concerns a process for purification of biodiesel obtained from castor seed oil, for the purpose of promoting the efficient separation of the glycerine fraction formed during the transesterification reaction of a mixture of long-chain triglycerides derived from the oil in the presence of ethanol and an alkaline catalyst.

The invention concerns the application of the electrostatic separation method to biodiesel from castor oil in order to separate the glycerine from the stable emulsion then formed, in a relatively short time.

The biodiesel purification process that is the subject matter of the present invention comprises the steps of:
removing partially by evaporation the excess of ethanol present in the mixture of esters which comprises 60% to 80% of alkydic esters, 5% to 15% of glycerine, and 15% to 30% of ethanol, using a heating bath to maintain the mixture at a temperature of approximately 90° C.;
adding to the mixture resulting from the evaporation of the ethanol approximately 0.7% of water and 2% to 5% of n-hexane, whilst homogenising it;
transferring the homogenised mixture to a decanting vessel provided with electrodes, promoting contact between said mixture and the glycerine stock existing in the decanting vessel, in a proportion of 10:1-5:1 by volume;
applying an alternating electrical current, provided by the operation of high voltage converters, preferably in the range 1-5 KV, in order to promote the electrostatic separation of the glycerine.

### DETAILED DESCRIPTION OF THE INVENTION

The present invention concerns the application of an electrostatic separation method, known as electrocoalescence, in order to separate the glycerine fraction. The phenomenon can be explained as follows:

Let us take as an example the separation of water dispersed in petroleum. The petroleum, being of organic nature, presents low electrical conductivity. On the other hand, the salts dispersed in the water give the dispersed phase a high electrical conductivity. When a droplet of water has a high intensity alternating current field applied to it, the drop of water elongates and dipoles are generated with an electrical charge in opposing directions. Another droplet that is located in the vicinity of the polarised droplet will also undergo polarisation but, through an inductive effect, its dipoles will present opposing electrical charges. The electrical interaction between the dipoles with opposing charges means that the two droplets are attracted leading to an impact and coalescence between these droplets.

In the present case, the dispersing phase and organic nature of biodiesel, presents low electrical conductivity, while the glycerine, in a dispersed phase, presents high electrical conductivity, mainly of being in the presence of ions of the alkaline catalyst in solution.

After the first step of the transesterification reaction of triglycerides in alkaline medium and necessarily anhydrous, the conversion factor is less than 90% expressed in moles of ester. The removal of the glycerine content in this case is obliged in order to conduct the second step of the reaction.

In the specific case in where it uses castor seed oil (which is highly hydroxylated) and ethanol, the situation is aggravated making it difficult the separation of the glycerine (also rich in hydroxyls) due to the formation of a stable system, with high involvement of polar forces, which requires decantation which can reach to 24 hours or more in order to the separation of the glycerine takes place. It is known that the excess of alcohol in the reaction medium is a critical factor in the separation of glycerine from the biodiesel.

In laboratory tests it was verified that the proper application of an electrical field of high voltage and low amperage in the core of the liquid mixture resulting from the first step promotes a rapid separation of the dispersed (polar) and dispersing (apolar) phases.

The electrical field initially promotes the polarisation of droplets of the glycerine phase (polar). An assortment sequentially polarised of the droplets takes place immediately in the dispersed phase when subjected to the electrical field. After reaching a minimum level of agglomeration the drops undergo rapid drainage of their interstitial film—comprising a thin layer of liquid from the external phase (esters). In this way larger drops are formed and finally the process advances through the coalescence of the drops followed by sedimentation through purely gravitational action.

### DESCRIPTION OF THE PREFERRED EMBODIMENT

In order to provide a better understanding of the invention, it will be explained using examples of a merely illustrative nature and which do not constitute any limitation to its practical application. It will be obvious to a person skilled in the art that other embodiments may be used without deviating from the inventive concept presented here.

### Example 1

### Applicability of the Electrostatic Separation Method to Biodiesel.

Initially the tests were performed in the laboratory, using apparatus comprising an electrical voltage transformer, and a graduated tube with a capacity of 100 ml containing the electrode, which was connected to a circulating heating bath at a temperature of 60° C.

Tests were carried out using liquors—the name given to the system resulting from the biodiesel production reaction—obtained from various vegetable oils, such as for example, sunflower, corn, canola, soya and castor seeds, by the transesterification reaction of the oil with ethanol, in the presence of sodium hydroxide (NaOH) as the catalyst. The liquors still containing dispersed the glycerine phase from the ester phase, were agitated, and transferred to the graduated tube and the electric voltage was immediately applied with the separation of the glycerine being observed throughout the time.

For the purposes of comparison the glycerine separation was also quantified using the traditional method that is to say by gravitational segregation without use of an electrical field. The results are presented in Table 1 as follows:

TABLE 1

| | | | | |
|---|---|---|---|---|
| | Voltage | Current | Separation | Efficiency |
| Liquor | (V) | (mA) | time | (%) |

| | | | | | |
|---|---|---|---|---|---|
| Sunflower | 1400 | 14.0 | 17 | s | 100 |
| | 1000 | 7.5 | 28 | s | 100 |
| | 900 | 5.0 | 29 | s | 100 |
| | 0 | 0 | 6 | min | 100 |
| Corn | 800 | 15.0 | 20 | s | 100 |
| | 1000 | 6.0 | 22 | s | 100 |
| | 900 | 4.0 | 28 | s | 100 |
| | 0 | 0 | 6 | min | 100 |
| Canola | 1500 | 14.0 | 15 | s | 100 |
| | 1000 | 5.0 | 20 | s | 100 |
| | 700 | 4.0 | 21 | s | 100 |
| | 0 | 0 | 6 | min | 100 |
| Soya | 2700 | 14.0 | 17 | s | 100 |
| | 1400 | 3.0 | 19 | s | 100 |
| | 900 | 5.0 | 27 | s | 100 |
| | 0 | 0 | 6 | min | 100 |

| | | | | |
|---|---|---|---|---|
| Castor | 2600 | 8.0 | — | 0 |
| seeds | | | | |

As it can be observed there was a rapid separation of the glycerine in the majority of cases, when the liquors were subjected to the electrical field with the exception of the castor seed oil; the performance of the separation for these oils tested was fairly similar. The increase in intensity of the electrical field was accompanied by the reduction in the separation time and, moreover this time was much less than the time necessary for the gravitational separation takes place).

### Example 2

### Effect of the Presence of Ethanol on the Separation.

The performance of the electrostatic separation of glycerine from biodiesel when in the presence of an excess of alcohol was observed adding ethanol to the liquors of the above example.

The results confirm that the excess of ethanol provides high stability to the system and can even prevent separation, as shown in Table 2.

TABLE 2

| | | | | Separation | |
|---|---|---|---|---|---|
| | Ethanol | Voltage | Current | time | Efficiency |
| Liquor | (%) | (V) | (mA) | (s) | (%) |
| Sunflower | 2.5 | 500 | 8.0 | — | 0 |
| Corn | 2.5 | 1500 | 14.0 | — | 0 |
| Canola | 2.5 | 2700 | 6.0 | — | 0 |
| Soya | 2.5 | 900 | 16.0 | 59 | 100 |
| | | 600 | 8.0 | 90 | 100 |
| | | 400 | 4.0 | 120 | 100 |
| | 5.0 | 1500 | 14.0 | — | 0 |

### Example 3

### Applicability to Castor Oil.

Since the separation of the glycerine phase was not observed when was used liquor obtained from castor seeds, new studies were conducted with the aim of solving this matter

So, part of the excess of ethanol was removed from the liquor obtained from castor seeds, with the aim of promoting the destabilisation of the dispersion, by means of evaporation, using a heating bath temperature of approximately 90° C. Ethanol content reductions of 5%, 10% and 15% were tested.

In order to increase the difference in polarity between the phases, n-hexane was added to the liquor in proportions of 2% and 5%, and water in a proportion of 0.7%. The results are presented below in Table 3.

TABLE 3

| | | | | Efficiency of separation of the glycerine from the biodiesel (%) | | | | | | | | | | | | |
|---|---|---|---|---|---|---|---|---|---|---|---|---|---|---|---|---|
| Ethanol | Hexane | Water | Voltage | 0.5 | 1.0 | 1.5 | 2.0 | 2.5 | 3.0 | 4.0 | 5.0 | 6.0 | 7.0 | 8.0 | 9.0 | 10.0 |
| (%) | (%) | (%) | (%) | min | min | min | min | min | min | min | min | min | min | min | min | min |
| −5 | 0 | 0 | 2650 | 0 | 0 | 0 | 0 | 0 | 0 | 0 | 0 | 0 | 0 | 0 | 0 | 0 |
| | 2 | 0 | 2550 | 0 | 0 | 0 | 0 | 0 | 0 | 0 | 0 | 0 | 0 | 0 | 0 | 0 |
| | | 0.7 | 2250 | 0 | 0 | 22 | 58 | 78 | 84 | 89 | 89 | 93 | 93 | 100 | 100 | 100 |
| | 5 | 0 | 2600 | 0 | 0 | 0 | 0 | 0 | 0 | 13 | 31 | 44 | 56 | 63 | 75 | 100 |
| | | | 1400 | 4 | 4 | 8 | 21 | 29 | 33 | 33 | 42 | 63 | 83 | 92 | 100 | 100 |
| | | | 800 | 0 | 0 | 0 | 0 | 0 | 0 | 0 | 0 | 7 | 20 | 20 | 67 | 100 |
| | | 0.7 | 2200 | 0 | 67 | 83 | 92 | 100 | 100 | 100 | 100 | 100 | 100 | 100 | 100 | 100 |
| | | | 1250 | 0 | 13 | 50 | 63 | 75 | 75 | 88 | 90 | 94 | 98 | 98 | 100 | 100 |
| | | | 850 | 0 | 7 | 21 | 50 | 71 | 83 | 89 | 100 | 100 | 100 | 100 | 100 | 100 |
| −10 | 0 | 0 | 2450 | 0 | 63 | 88 | 98 | 100 | 100 | 100 | 100 | 100 | 100 | 100 | 100 | 100 |
| | | | 1600 | 0 | 44 | 67 | 78 | 87 | 89 | 91 | 98 | 100 | 100 | 100 | 100 | 100 |
| | | | 900 | 0 | 0 | 12 | 35 | 71 | 76 | 92 | 94 | 100 | 100 | 100 | 100 | 100 |
| | 2 | 0 | 2100 | 0 | 75 | 88 | 98 | 100 | 100 | 100 | 100 | 100 | 100 | 100 | 100 | 100 |
| | | | 1000 | 0 | 56 | 78 | 87 | 89 | 91 | 100 | 100 | 100 | 100 | 100 | 100 | 100 |
| | | | 900 | 0 | 0 | 44 | 67 | 78 | 83 | 89 | 89 | 94 | 100 | 100 | 100 | 100 |
| | | 0.7 | 2450 | 22 | 72 | 83 | 89 | 94 | 94 | 100 | 100 | 100 | 100 | 100 | 100 | 100 |
| | | | 1650 | 0 | 53 | 74 | 84 | 89 | 95 | 95 | 95 | 100 | 100 | 100 | 100 | 100 |
| | | | 1000 | 0 | 0 | 33 | 67 | 78 | 83 | 89 | 100 | 100 | 100 | 100 | 100 | 100 |
| | 5 | 0 | 2500 | 25 | 75 | 95 | 100 | 100 | 100 | 100 | 100 | 100 | 100 | 100 | 100 | 100 |
| | | | 1650 | 11 | 67 | 78 | 89 | 89 | 91 | 98 | 100 | 100 | 100 | 100 | 100 | 100 |
| | | | 900 | 0 | 56 | 67 | 78 | 89 | 89 | 89 | 100 | 100 | 100 | 100 | 100 | 100 |
| | | 0.7 | 2700 | 70 | 88 | 90 | 95 | 98 | 100 | 100 | 100 | 100 | 100 | 100 | 100 | 100 |
| | | | 1600 | 60 | 80 | 90 | 92 | 92 | 96 | 98 | 100 | 100 | 100 | 100 | 100 | 100 |
| | | | 1000 | 0 | 71 | 82 | 92 | 92 | 97 | 100 | 100 | 100 | 100 | 100 | 100 | 100 |
| −15 | 0 | 0 | 2650 | 40 | 80 | 90 | 90 | 100 | 100 | 100 | 100 | 100 | 100 | 100 | 100 | 100 |
| | | | 1700 | 30 | 80 | 80 | 90 | 96 | 100 | 100 | 100 | 100 | 100 | 100 | 100 | 100 |
| | | | 1000 | 0 | 20 | 70 | 80 | 90 | 90 | 98 | 100 | 100 | 100 | 100 | 100 | 100 |
| | 2 | 0 | 2650 | 50 | 80 | 84 | 90 | 95 | 98 | 100 | 100 | 100 | 100 | 100 | 100 | 100 |
| | | | 1400 | 26 | 68 | 78 | 87 | 87 | 90 | 90 | 96 | 96 | 100 | 100 | 100 | 100 |
| | | 0.7 | 3000 | 80 | 90 | 100 | 100 | 100 | 100 | 100 | 100 | 100 | 100 | 100 | 100 | 100 |
| | | | 1600 | 60 | 90 | 90 | 100 | 100 | 100 | 100 | 100 | 100 | 100 | 100 | 100 | 100 |
| | | | 1000 | 0 | 50 | 80 | 90 | 90 | 100 | 100 | 100 | 100 | 100 | 100 | 100 | 100 |
| | 5 | 0 | 2500 | 60 | 80 | 90 | 92 | 98 | 100 | 100 | 100 | 100 | 100 | 100 | 100 | 100 |
| | | | 1650 | 60 | 80 | 90 | 92 | 98 | 100 | 100 | 100 | 100 | 100 | 100 | 100 | 100 |
| | | | 900 | 0 | 60 | 80 | 90 | 90 | 90 | 96 | 100 | 100 | 100 | 100 | 100 | 100 |
| | | 0.7 | 2400 | 80 | 90 | 98 | 100 | 100 | 100 | 100 | 100 | 100 | 100 | 100 | 100 | 100 |
| | | | 1350 | 64 | 82 | 89 | 91 | 91 | 91 | 100 | 100 | 100 | 100 | 100 | 100 | 100 |
| | | | 900 | 9 | 55 | 73 | 82 | 91 | 93 | 100 | 100 | 100 | 100 | 100 | 100 | 100 |

It was found that the removal of part of the ethanol from the liquor obtained from the castor seeds allowed the method to be applied and, consequently, the separation of the glycerine which previously did not happen.

Moreover, the increased removal of the ethanol was accompanied by an increased separation of the glycerine (with the removal of 15% of the ethanol separation took place in a relatively short time.

### Example 4

### Specific Example of the Invention.

Bearing in mind that the aim of the invention is to obtain biodiesel from castor seed oil, a practical application on a pilot scale of this invention is the installation of electrodes, powered by converters of high voltage (1 to 5 KV) in horizontal decanting vessels, originally intended for the gravitational separation of the glycerine phase contained in the ternary system removed from the transesterification reactor.

The lower part of the decanting vessel contains up to 50% of the total volume of the vessel by glycerine volume (stock). The liquor originating from the reactor has a composition of 60% to 80% of alkydic esters (biodiesel), 5% to 15% of glycerol (by-product), and 15% to 30% of alcohol (excess non reacted). The passing of this liquor as a continuous flow through this layer of glycerine in a proportion of up to 10:1 by volume will promote the saturation of the system.

The saturated mixture is subjected to the electric field which promotes the polarisation, coalescence and decantation steps of the dispersed phase (glycerine). In view of that catalyst used also presents a polar characteristic, this is decanted together with the glycerine phase.

Simultaneously is employed a mixture of polar\apolar liquid pairs, for example water and n-hexane, in suitable proportions, in order to provide greater differentiation of the polarity indices between the esters fraction and the glycerine fraction. The combination of the two effects favours the destabilisation of systems that are highly resistant to conventional separation by simple decantation.

In this system group it is found the biodiesel produced from castor oil, which is known to present difficulties in the separation of phases due to the presence of a hydroxyl group (OH) in the 12^{th} carbon in a chain of 18 atoms of ricinoleic acid

It was found that the prior addition of n-hexane and water in a ratio of 5:1 by volume to the ternary system of the biodiesel from castor oil, followed by the application of alternating current (AC) of 2 KV favour substantially the separation of the dispersed and dispersing phases, in a time of the order of up to 10 seconds, depending on the operational conditions employed.

1- PROCESS FOR PURIFICATION OF BIODIESEL, obtained from the transesterification of castor seed oil in the presence of ethanol and an alkaline catalyst characterised by separating the glycerine formed during the transesterification reaction, in a drastically reduced time, comprising the steps of:
partially removing by evaporation the excess of ethanol present in the mixture of esters which is composed of 60% to 80% of alkydic esters, 5% to 15% of glycerine, and 15% to 30% of ethanol, using a heating bath to keep the mixture warm;
adding to the mixture resulting from the evaporation of the ethanol approximately 0.7% of water and 2% to 5% of n-hexane, whilst homogenising it;
transferring the homogenised mixture to a decanting vessel provided with electrodes, promoting contact between said mixture and the glycerine stock existing in the decanting vessel, in a proportion of 10:1 to 5:1 by volume;
applying an alternating electrical current, provided by the operation of high voltage converters, preferably in the range 1 to 5 KV, in order to promote the electrostatic separation of the glycerine.

2- PROCESS FOR PURIFICATION OF BIODIESEL, according to claim 1, characterised by reducing the stability of the emulsion formed by the esters/ethanol/glycerine system, by means of the application of a high voltage electric field.

3- PROCESS FOR PURIFICATION OF BIODIESEL, according to claim 1, characterised by initially removing approximately 5% to 15% by volume of ethanol from the mixture of esters.

4- PROCESS FOR PURIFICATION OF BIODIESEL, according to claim 1, characterised by using a heating bath to maintain the esters/ethanol/glycerine mixture at a temperature of approximately 90° C.

5- PROCESS FOR PURIFICATION OF BIODIESEL, according to claim 1, characterised by the time for separation of the glycerine being drastically reduced as a function of the operational conditions employed.
